(19) United States
(12) Patent Application Publication
(10) Pub. No.: US 2006/0133781 A1
(43) Pub. Date: Jun. 22, 2006

(54) DVD random shuffle method

(76) Inventors: Rock Lane, Santa Monica, CA (US); John Volturo, Los Angeles, CA (US); Andrew Spivak, Santa Monica, CA (US); Rick Watson, Santa Ana, CA (US); Lee Evans, Santa Monica, CA (US)

Correspondence Address: CISLO & THOMAS, LLP, 233 WILSHIRE BLVD, SUITE 900, SANTA MONICA, CA, 90401-1211, US

(21) Appl. No.: 11/015,997

(22) Filed: Dec. 17, 2004

(51) Int. Cl. H04N 5/85

(52) U.S. Cl. 386/126

(57) ABSTRACT

A DVD random shuffle method includes adapting a DVD player to play a pre-set initial routine, and instructing the DVD player to present a subsequent routine selection to a user. The subsequent routine selection is between a first pre-set routine and a second routine. The second routine is a random re-sequencing of the first pre-set routine. The method also includes directing the DVD player to play one of the first and second routines depending on the routine selection of the user, and thereafter, commanding the DVD player to play a pre-set terminal routine.

### BACKGROUND

DVD (“Digital Versatile Disc”) media is read using a player or reader designed for that purpose. Information is stored on DVD media in digital form. DVD media contains areas of high reflectivity (land) and low reflectivity (pit). When read with a laser, a transition from land to pit or from pit to land represents a “1”, with all other areas representing a “0”. The DVD player includes a laser assembly that shines a laser beam onto the surface of the disc to read the pattern of lands and pits. The DVD player decodes the digital video stream which may contain codecs of MPEG-2 (Moving Picture Experts Group) video, Dolby AC-3 (Advanced Codec 3), PCM (Pulse Code Modulation) and/or MPEG audio streams, amplifies the decoded audio/video streams and sends the amplified signal to the speakers and video display, respectively.

A DVD contains three primary types of streams, namely, video, audio and subpicture streams. The video stream may contain up to nine viewing angles. Only one viewing angle may be active at a time. The video stream may also contain Line 21 closed caption data. The DVD may have up to eight separate audio streams, or tracks, providing up to eight multi-channel soundtracks and allowing DVD karaoke discs to make use of multi-channel audio. The DVD may contain up to 32 subpicture streams containing bitmap graphics that are used for menu buttons and subtitles. The subpicture data streams are independent of the closed caption data in the video stream. Typically, if a DVD contains subpicture and closed caption data, both types of data cannot be displayed at the same time by the player.

Some of the features that make DVDs attractive to users are multiple languages, parental control, karaoke support, and multiple viewing angles. The DVD player plays back audio, video, and subpicture streams, and keeps track of the navigation options that the input disc is programmed to permit.

Audio and video data on a DVD is interleaved at regular intervals with various kinds of navigation control data. This data may be an instruction that tells the player to perform a specific task, or it may be a marker left by the DVD author informing the DVD player that certain features are disabled. The player relays the information to an appropriate application, and it is the responsibility of the application to act on it. The player application handles events that originate with the disc as well as events that originate with the user, such as via a remote controller.

In a DVD karaoke disc, songs are formatted as titles, whereby titles may be grouped into title sets based on performer, musical style, or other criteria. Karaoke discs contain multi-channel audio, such as Dolby AC-3. Channels 0 and 1 always contain the background instrumental music, while channels 2 through 5 can each contain any combination of guide vocals, guide melodies, and/or sound effects. A typical karaoke application controls the volume and destination speaker for each auxiliary channel.

### SUMMARY

Exemplary embodiments disclosed herein are generally directed to a DVD random shuffle method.

In accordance with one aspect of the invention, the DVD random shuffle method comprises the steps of adapting a DVD player to play a pre-set initial routine, and instructing the DVD player to present a subsequent routine selection to a user. The subsequent routine selection is between a first pre-set routine and a second routine. The second routine is a random re-sequencing of the first pre-set routine. The method further comprises the steps of directing the DVD player to play one of the first and second routines depending on the routine selection of the user, and commanding the DVD player to play a pre-set terminal routine.

In accordance with another aspect of the invention, the DVD random shuffle method comprises the steps of inserting a DVD in a DVD player, wherein the DVD is adapted to instruct the DVD player to play a pre-set initial routine, and utilizing the DVD to direct the DVD player to present a subsequent routine selection to a user. The subsequent routine selection is between a first pre-set routine and a second routine. The second routine is a random re-sequencing of the first pre-set routine. The method further comprises the step of using the DVD to instruct the DVD player to play one of the first and second routines depending on the routine selection of the user. The DVD is adapted to instruct the DVD player to play a pre-set terminal routine. The method also comprises the step of ejecting the DVD from the DVD player.

In accordance with yet another aspect of the invention, the DVD random shuffle method comprises the steps of adapting a DVD player to play a pre-set initial routine, and instructing the DVD player to present a subsequent routine selection to a user. The subsequent routine selection is between a first pre-set routine and a second routine. The second routine is a random re-sequencing of the first pre-set routine. The method further comprises the steps of directing the DVD player to play the first routine if the first routine is selected by the user, and commanding the DVD player to play a pre-set terminal routine.

In accordance with still another aspect of the invention, the DVD random shuffle method comprises the steps of adapting a DVD player to play a pre-set initial routine, and instructing the DVD player to present a subsequent routine selection to a user. The subsequent routine selection is between a first pre-set routine and a second routine. The second routine is a random re-sequencing of the first pre-set routine. The method further comprises the steps of directing the DVD player to play the second routine, if the second routine is selected subsequent to the first routine not being selected by the user, and commanding the DVD player to play a pre-set terminal routine.

In accordance with a different aspect of the invention, the DVD random shuffle method comprises the steps of adapting a DVD player to play a pre-set initial routine, and instructing the DVD player to present a subsequent routine selection to a user. The subsequent routine selection is between a first pre-set routine and a second routine. The second routine is a random re-sequencing of the first pre-set routine. The method further comprises the steps of directing the DVD player to play the second routine if the second routine is selected by the user, and commanding the DVD player to play a pre-set terminal routine.

In accordance with a still different aspect of the invention, the DVD random shuffle method comprises the steps of adapting a DVD player to play a pre-set initial routine, and instructing the DVD player to present a subsequent routine selection to a user. The subsequent routine selection is between a first pre-set routine and a second routine. The second routine is a random re-sequencing of the first pre-set routine. The method further comprises the steps of directing the DVD player to play the first routine, if the first routine is selected subsequent to the second routine not being selected by the user, and commanding the DVD player to play a pre-set terminal routine.

In accordance with an alternative aspect of the invention, the DVD random shuffle method comprises the steps of inserting a DVD in a DVD player with the DVD being adapted to instruct the DVD player to play a pre-set initial routine, and utilizing the DVD to direct the DVD player to present a subsequent routine selection to a user in the form of a menu on an associated video display. The subsequent routine selection is between a first pre-set routine and a second routine. The second routine is a random re-sequencing of the first pre-set routine. The method further comprises the step of using the DVD to instruct the DVD player to play one of the first and second routines depending on the routine selection of the user. The DVD is adapted to instruct the DVD player to play a pre-set terminal routine. Another step includes utilizing the DVD to instruct the DVD player to exhibit the user menu on the associated video display.

These and other aspects of the invention will become apparent from a review of the accompanying drawings and the following detailed description of the invention.

### BRIEF DESCRIPTION OF THE DRAWINGS

The invention is generally shown by way of reference to the accompanying drawings in which:

FIG. 1 is an operational flow chart of a DVD random shuffle method in accordance with an exemplary embodiment of the present invention; and

FIG. 2 is an operational flow chart of a DVD random shuffle method in accordance with another exemplary embodiment of the present invention.

### DETAILED DESCRIPTION

The detailed description set forth below in connection with the appended drawings is intended as a description of exemplary embodiments and is not intended to represent the only forms in which the exemplary embodiments may be constructed and/or utilized. The description sets forth the functions and the sequence of steps for constructing and operating the exemplary embodiments in connection with the illustrated embodiments. However, it is to be understood that the same or equivalent functions and sequences may be accomplished by different embodiments that are also intended to be encompassed within the spirit and scope of the invention.

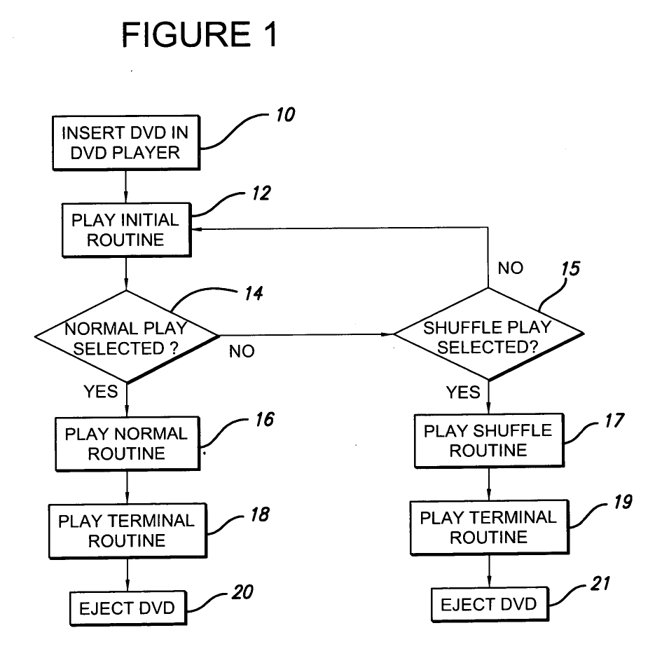

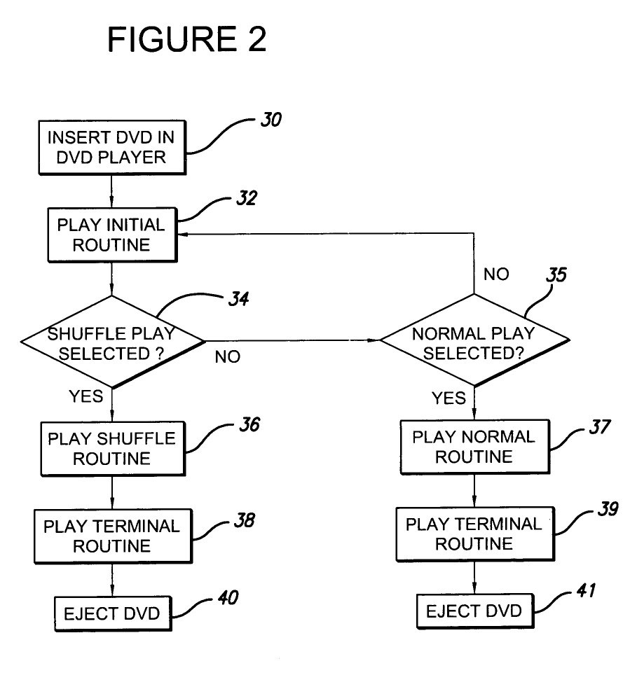

Some embodiments of the invention will be described in detail with reference to the related drawings of FIGS. 1-2. Additional embodiments, features and/or advantages of the invention will become apparent from the ensuing description or may be learned by practicing the invention. In the figures, the drawings are not to scale with like numerals referring to like features throughout both the drawings and the description.

A DVD may be programmed by the DVD author to follow a certain playback sequence to enhance the user viewing experience. For example, the DVD may contain instructions for the DVD player to start and end playback with pre-set routines. The DVD may be programmed to instruct the player to provide various playback options between the pre-set start/end routines. One option may include randomly shuffling a set of routines, such as playing back randomly re-sequenced blocks of workout exercises, songs, video clips and/or the like. The random shuffling may be preceded by the user deciding which block of exercises or songs he/she would like to randomize. For example, workout exercises may be grouped by muscle group(s), gender, level of proficiency, etc. The songs may be grouped by music style, e.g. country, disco, pop, classics, as well as by composer, performer, etc. A DVD with such functionality would provide the user with a different, randomly customized workout or music experience every time the user starts playback of a randomly shuffled routine when the DVD is played in the player.

Another option may follow an ordered set of routines, such as playing back only country clips, or only disco clips, etc. The DVD may be also programmed to instruct the DVD player to utilize its subtitle feature to provide karaoke-type functionality via the remote controller. For example, the user may push the subtitle button on the remote controller to view the lyrics of the currently playing music track, song or the like, if karaoke experience is desired.

FIG. 1 is an operational flow chart of a DVD random shuffle method in accordance with an exemplary embodiment of the present invention. Specifically, after a DVD has been inserted in a DVD player, step 10, the DVD instructs the DVD player to play an initial routine, step 12. The initial routine may be a warm-up exercise block including bouncing, torso stretches, and arm stretches. Alternatively, the initial routine may include an interview with a music performer, composer or the like. The DVD player is then instructed to question the user via an associated video display, whether the user wishes to select a “normal play” routine, step 14, or a random “shuffle play” routine, step 15. A menu may be shown on the video display providing the user with two choices, “normal play” or “shuffle play.” The “normal play” routine may include a pre-set order of workout exercises, as follows:
(1) squatting with a ball overhead/to the floor, split-squatting with the ball overhead, performing three (3) push-ups on the ball, and ball roll-outs;
(2) dumbbell rows, dumbbell clean and press, one-legged squatting, oblique crunching on a ball;
(3) seated leg extensions, one-arm lateral raise, weighted crunches on a ball;
(4) lower body hyperextensions, upper body hyperextensions, plank leg lifts on a ball, seated side twists;
(5) hamstring bridge rollouts, one-legged hamstring lift, lying triceps extensions, lower abdominal twists;
(6) bicep curls, bent-over lateral raise, lunges/side/twist-back lunges, twisting crunches; and
(7) dumbbell front raises, hip raises, lying ball passes, lying wood-chops, center lying ball thrusts.

The random “shuffle play” routine may include, for example, a random re-sequencing of workout exercise groups (1)-(7). A random shuffling of these exercise groups may be implemented, for example, in the following order: (3), (1), (2), (5), (6), (4), and (7).

If “normal play” is selected, the DVD instructs the player to play back the normal (pre-set) routine, step 16, e.g. workout exercise groups (1)-(7). Thereafter, the DVD player is instructed to play a pre-set terminal routine, step 18. For example, the terminal routine may include a cool-down/stretch block of exercises, as follows:
(1) seated torso twist;
(2) hip flexor stretch;
(3) calf stretch;
(4) side stretch;
(5) kneeling chest/forearm stretch;
(6) sprawl stretch over a ball; and
(7) hurdle/hamstring stretch on the ball.

After completion of the terminal routine, the DVD player is ordered to eject the DVD, step 20 (FIG. 1). An alternative closing may include the DVD instructing the DVD player to exhibit the menu via an associated video display in case the user would like to make a selection (between “normal play” and “shuffle play”) again. Other closing variations are possible, provided such variations do not depart from the intended purpose of the present invention. The initial and terminal routines are never randomized.

If “normal play” is not selected by the user via the DVD player remote controller, the user has the option of selecting the random “shuffle play” routine, step 15. If the “shuffle play” routine is selected by the user, the DVD directs the player to randomly shuffle the pre-set normal routine, step 17. Thereafter, the DVD player is instructed to play the pre-set terminal routine, step 19. An example of a terminal routine is outlined hereinabove. After completion of the terminal routine, the DVD player is ordered to eject the DVD, step 21 (FIG. 1). An alternative closing may include the DVD instructing the DVD player to exhibit the menu via an associated video display in case the user would like to make a selection (between “normal play” and “shuffle play”) again. Other closing variations may be utilized, provided such variations reside within the intended scope of the present invention.

If “shuffle play” is not selected by the user, the DVD directs the DVD player to perform step 12 again, exhibit via an associated video display the user menu (containing two choices, “normal play” or “shuffle play”), and the process repeats, as generally shown in FIG. 1.

FIG. 2 is an operational flow chart of a DVD random shuffle method in accordance with another exemplary embodiment of the present invention. Specifically, after a DVD has been inserted in a DVD player, step 30, the DVD instructs the DVD player to play an initial routine, step 32. The initial routine may be a warm-up exercise block, as outlined hereinabove in reference to FIG. 1.

Thereafter, the DVD player is instructed to question the user via an associated video display, whether the user wishes to select a random “shuffle play” routine, step 34, or a “normal play” routine, step 35. A menu may be shown on the video display providing the user with two choices, “normal play” or “shuffle play.” The “normal play” routine may include a pre-set order of workout exercises, as outlined hereinabove in reference to FIG. 1. The random “shuffle play” routine may include, for example, a random re-sequencing of workout exercise groups (1)-(7). If the “shuffle play” routine is selected by the user, the DVD directs the player to randomly shuffle the pre-set normal routine, step 36. Thereafter, the DVD player is instructed to play a pre-set terminal routine, step 38. An example of a terminal routine is outlined hereinabove in reference to FIG. 1.

After completion of the terminal routine, the DVD player is ordered to eject the DVD, step 40 (FIG. 2). An alternative closing may include the DVD instructing the DVD player to exhibit the menu via an associated video display in case the user would like to make a selection (between “normal play” and “shuffle play”) again. Other closing variations are possible, provided such variations do not depart from the intended purpose of the present invention.

If the “shuffle play” routine is not selected, the user has the option of selecting the “normal play” routine, step 35. If “normal play” is selected, the DVD instructs the player to play back the normal (pre-set) routine, step 37. Thereafter, the DVD player is instructed to play the pre-set terminal routine, step 39. After completion of the terminal routine, the DVD player is ordered to eject the DVD, step 41 (FIG. 2). An alternative closing may include the DVD instructing the DVD player to exhibit the menu via an associated video display in case the user would like to make a selection (between “normal play” and “shuffle play”) again. Other closing variations may be utilized, provided such variations reside within the intended scope of the present invention.

If “normal play” is not selected by the user via the DVD player remote controller, the DVD directs the player to perform step 32 again, exhibit via an associated video display the user menu (containing two choices, “normal play” or “shuffle play”), and the process repeats, as generally shown in FIG. 2.

The DVD random shuffle method of the present invention provides users, choosing the random shuffle play functionality included with the DVD, with a unique experience every time the DVD is played. User experience may be further enhanced by programming the DVD to allow the DVD player to utilize subtitles to provide karaoke-type functionality via the remote controller.

A person skilled in the art would appreciate that exemplary embodiments described hereinabove are merely illustrative of the general principles of the present invention. Other modifications or variations may be employed that are within the scope of the invention. Thus, by way of example, but not of limitation, alternative configurations may be utilized in accordance with the teachings herein. Accordingly, the drawings and description are illustrative and not meant to be a limitation thereof.

Moreover, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Thus, it is intended that the invention cover all embodiments and variations thereof as long as such embodiments and variations come within the scope of the appended claims and their equivalents.

What is claimed is:

1. A DVD (“Digital Versatile Disc”) random shuffle method, comprising the steps of:
adapting a DVD player to play a pre-set initial routine;
instructing said DVD player to present a subsequent routine selection to a user, said subsequent routine selection being between a first pre-set routine and a second routine, said second routine being a random re-sequencing of the first pre-set routine;
directing said DVD player to play one of said first and second routines depending on said routine selection of the user; and
commanding said DVD player to play a pre-set terminal routine.

2. A DVD (“Digital Versatile Disc”) random shuffle method, comprising the steps of:
inserting a DVD in a DVD player, said DVD being adapted to instruct the DVD player to play a pre-set initial routine;
utilizing said DVD to direct the DVD player to present a subsequent routine selection to a user, said subsequent routine selection being between a first pre-set routine and a second routine, said second routine being a random re-sequencing of the first pre-set routine;
using said DVD to instruct the DVD player to play one of said first and second routines depending on said routine selection of the user, said DVD being adapted to instruct the DVD player to play a pre-set terminal routine; and
ejecting said DVD from the DVD player.

3. A DVD (“Digital Versatile Disc”) random shuffle method, comprising the steps of:
adapting a DVD player to play a pre-set initial routine;
instructing said DVD player to present a subsequent routine selection to a user, said subsequent routine selection being between a first pre-set routine and a second routine, said second routine being a random re-sequencing of the first pre-set routine;
directing said DVD player to play said first routine if said first routine is selected by the user; and
commanding said DVD player to play a pre-set terminal routine.

4. A DVD (“Digital Versatile Disc”) random shuffle method, comprising the steps of:
adapting a DVD player to play a pre-set initial routine;
instructing said DVD player to present a subsequent routine selection to a user, said subsequent routine selection being between a first pre-set routine and a second routine, said second routine being a random re-sequencing of the first pre-set routine;
directing said DVD player to play said second routine if said second routine is selected subsequent to said first routine not being selected by the user; and
commanding said DVD player to play a pre-set terminal routine.

5. The DVD random shuffle method of claim 4, further comprising the step of repeating the initial routine and subsequent routine selection steps, if said second routine is not selected subsequent to said first routine not being selected by the user.

6. A DVD (“Digital Versatile Disc”) random shuffle method, comprising the steps of:
adapting a DVD player to play a pre-set initial routine;
instructing said DVD player to present a subsequent routine selection to a user, said subsequent routine selection being between a first pre-set routine and a second routine, said second routine being a random re-sequencing of the first pre-set routine;
directing said DVD player to play said second routine if said second routine is selected by the user; and
commanding said DVD player to play a pre-set terminal routine.

7. A DVD (“Digital Versatile Disc”) random shuffle method,.comprising the steps of:
adapting a DVD player to play a pre-set initial routine;
instructing said DVD player to present a subsequent routine selection to a user, said subsequent routine selection being between a first pre-set routine and a second routine, said second routine being a random re-sequencing of the first pre-set routine;
directing said DVD player to play said first routine if said first routine is selected subsequent to said second routine not being selected by the user; and
commanding said DVD player to play a pre-set terminal routine.

8. The DVD random shuffle method of claim 7, further comprising the step of repeating the initial routine and subsequent routine selection steps, if said first routine is not selected subsequent to said second routine not being selected by the user.

9. The DVD random shuffle method of claim 1, wherein said DVD player has a subtitling feature.

10. The DVD random shuffle method of claim 9, further comprising the step of adapting said DVD player to utilize said subtitling feature to provide karaoke-type functionality via a remote controller.

11. The DVD random shuffle method of claim 1, wherein said first pre-set routine is selected by the user from a block of pre-set routines, said DVD player being adapted to allow the user to make the pre-set routine selection via a remote controller.

12. The DVD random shuffle method of claim 1, wherein said subsequent routine selection is presented to the user in the form of a menu on an associated video display, said DVD player and said associated video display being adapted to allow the user to make a menu selection via a remote controller.

13. A DVD (“Digital Versatile Disc”) random shuffle method, comprising the steps of:
inserting a DVD in a DVD player, said DVD being adapted to instruct the DVD player to play a pre-set initial routine;
utilizing said DVD to direct the DVD player to present a subsequent routine selection to a user in the form of a menu on an associated video display, said subsequent routine selection being between a first pre-set routine and a second routine, said second routine being a random re-sequencing of the first pre-set routine;
using said DVD to instruct the DVD player to play one of said first and second routines depending on said routine selection of the user, said DVD being adapted to instruct the DVD player to play a pre-set terminal routine; and
utilizing said DVD to instruct the DVD player to exhibit said user menu on the associated video display.
